(19) United States
(12) Patent Application Publication
(10) Pub. No.: US 2026/0133459 A1
(43) Pub. Date: May 14, 2026

(54) LOW-TEMPERATURE SOLID POLYMER ELECTROLYTE FOR ELECTROCHROMIC DEVICES

(71) Applicant: LannRay Advanced Materials Co. LTD, Ningbo (CN)

(72) Inventors: Danyang LI, Ningbo (CN); Miaozi LI, Ningbo (CN); Xiongwei WANG, Ningbo (CN); Yan ZHOU, Ningbo (CN); Jing WANG, Ningbo (CN)

(21) Appl. No.: 19/376,028

(22) Filed: Oct. 31, 2025

(30) Foreign Application Priority Data
Nov. 11, 2024 (CN) 202411600824.2

(51) Int. Cl. G02F 1/15

(52) U.S. Cl. CPC G02F 1/15; G02F 2001/164

(57) ABSTRACT

Disclosed is a low-temperature solid polymer electrolyte for electrochromic devices. The solid polymer electrolyte may include one or more ionic liquids, one or more polymers, one or more electrolyte salts, one or more curing agents, and one or more solvents. The solid polymer electrolyte is processed by means of slot die coating, followed by thermal curing or UV curing. The solid polymer electrolyte still can maintain an ion transport function at −20° C. The solid polymer electrolyte, when used in electrochromic devices, enables an electrochromic device to still operate normally at low temperatures.

### CROSS-REFERENCE TO RELATED APPLICATIONS

This application claims priority to Chinese Patent Application No. 202411600824.2, filed with the China National Intellectual Property Administration on Nov. 11, 2024, which is incorporated herein by reference in its entirety.

### TECHNICAL FIELD

The present application relates to a low-temperature solid polymer electrolyte for electrochromic devices and belongs to the technical field of organic solid polymer electrolytes.

### BACKGROUND

An electrochromic device can cause a reversible change in color of an electrochromic material upon application of a voltage. The use of electrochromic technology in automotive sunroofs can achieve the effect of sun shading and heat insulation. Electrolyte layers play a key role in ion transport in electrochromic devices.

The rate of ion transport is closely related to temperature, and it is difficult for ions to move at low temperatures. For example, Chinese Patent Application No. 201780005574.X, issued as Chinese Patent No. 108463912, previously filed by the Applicant solves several technical problems and shortcomings of existing electrochromic devices and solid electrolytes used therein, but it still fails to solve the problem that electrochromic devices and the solid electrolytes used therein hardly operate at low temperatures. Currently, a solid electrolyte that can still transport ions at a temperature below zero is still a significant challenge. The inability to operate normally at low temperatures greatly restricts the application of electrochromism in automotive sunroofs and other areas.

### SUMMARY

An object of the present application is to solve the problem that an electrochromic device can hardly operate at low temperatures, and to provide a low-temperature solid polymer electrolyte so that the electrochromic device can still operate normally at low temperatures.

In order to solve the above technical problem, the present application provides the following technical solutions:

In one aspect, the present application provides a low-temperature solid polymer electrolyte, including:
one or more ionic liquids;
one or more polymers;
one or more electrolyte salts;
one or more curing agents; and
one or more solvents.

Preferably, the one or more ionic liquid include one or more of pyridine-based, pyrrole-based, imidazole-based, and piperidine-based ionic liquids;
and/or, the one or more electrolyte salts include one or more metal salts;
and/or, the one or more curing agents include one or more of an amine-based curing agent, an anhydride-based curing agent, and a thiol-based curing agent.

Preferably, the one or more polymer include one or more of polymethyl methacrylate (PMMA), polytetrafluoroethylene (PTFE), polyvinylidene fluoride (PVDF), poly(vinylidene fluoride-co-hexafluoropropylene) (PVDF-HFP), polyethylene oxide, polyethylene glycol diglycidyl ether, polyethylene glycol diacrylate, and polyethylene terephthalate.

Preferably, the one or more ionic liquids include one or more of N-methyl-N-ethylpyrrolidinium bis(trifluoromethylsulfonyl)imide, N-butyl-N-methylpyrrolidinium bis(trifluoromethanesulfonyl)imide, 1-allyl-3-methylimidazolium bis(trifluoromethylsulfonyl)imide, 1-ethyl-3-methylimidazolium chloride, 1-ethyl-3-methylimidazolium bis(trifluoromethylsulfonyl)imide, 1-butyl-3-methylimidazolium bis(trifluoromethylsulfonyl)imide, 1-hexyl-3-methylimidazolium bis(trifluoromethylsulfonyl)imide, 1-vinyl-3-butylimidazolium bis(trifluoromethylsulfonyl)imide, N-hexyl-4-methylpyridinium bis(trifluoromethylsulfonyl)imide, N-ethylpyridinium bis(trifluoromethanesulfonyl)imide, N-butylpyridinium trifluoromethanesulfonate, and N-hexyl-N-methylpiperidinium bis(trifluoromethanesulfonyl)imide.

Preferably, the metal salt is a metal lithium salt.

Preferably, the metal lithium salt includes one or more of LiBOB, LiFSI, LiTFSI, LiPF₆, LiBF₄, LiClO₄ and LiCF₃SO₃.

Preferably, the amine-based curing agent includes one or more of polyamide, triethylene tetramine, tetraethylene pentamine, and m-xylylenediamine;
and/or, the anhydride-based curing agent includes one or more of phthalic anhydride, methylcyclohexenetetracarboxylic dianhydride;
and/or, the thiol-based curing agent includes one or more of ethylene glycol dimercaptoacetate, 1,4-butanediol bis(3-mercaptopropionate), and trimethylolpropane tris (3-mercaptopropionate).

Preferably, the one or more solvent comprises a solvent with a boiling point above 60° C.

Preferably, the one or more solvents include one or more of isopropanol, sec-butanol, butanone, propylene glycol methyl ether acetate, propylene carbonate, and diethyl carbonate.

Preferably, the low-temperature solid polymer electrolyte has a transparency of at least 80%.

In another aspect, the present application provides the use of the low-temperature solid polymer electrolyte described above in an electrochromic device.

In yet another aspect, the present application provides an electrochromic device, including:
a first electrode;
a second electrode;
an electrochromic material deposited on at least the first electrode; and a low-temperature solid polymer electrolyte arranged between the electrochromic material and the second electrode; wherein
the low-temperature solid polymer electrolyte is the low-temperature solid polymer electrolyte as described above.

Compared with the prior art, the present application has the following beneficial effects:

The low-temperature solid polymer electrolyte of the present invention has sufficient mechanical strength and arbitrary shape, and can form films and film-shaped products. Compared with conventional polymer electrolytes, the present invention introduces ionic liquids which presents better ionic conductivity at low temperatures.

### BRIEF DESCRIPTION OF THE DRAWINGS

FIG. 1 shows dark-to-bright state transmission-time curves of a 500 mm*500 mm electrochromic device including a low-temperature solid polymer electrolyte therein, measured at −5° C., −9° C., −12.9° C., and −20° C., according to an exemplary embodiment.

FIG. 2 shows bright-to-dark state transmittance-time curves of a 500 mm*500 mm electrochromic device, measured at −5° C., −9° C., −12.9° C., and −20° C.

### DETAILED DESCRIPTION OF THE EMBODIMENTS

For ease of understanding, the invention will be described in further detail below with reference to the accompanying drawings and specific embodiments. It should be understood that these embodiments are only used to illustrate the invention but not to limit the scope of the invention.

One aspect of the application relates to a solid polymer electrolyte. In some embodiments, the solid polymer electrolyte may include one or more ionic liquids, one or more polymers, one or more electrolyte salts, one or more curing agents, and one or more solvents.

Another aspect of the present application relates to an electrochromic device. In some embodiments, the electrochromic device includes a first electrode, a second electrode, a charge storage layer and an electrochromic material respectively deposited on the electrodes, and a solid polymer electrolyte disposed therein. The solid polymer electrolyte may include one or more ionic liquids, one or more polymers, one or more electrolyte salts, one or more curing agents, and one or more solvents.

The term “ionic liquid” refers to room-temperature ionic liquids, room-temperature molten salts, or organic ionic liquids, etc., which are composed of organic cations and inorganic or organic anions.

According to the present application, the one or more ionic liquids may include one or more of pyridine-based, pyrrole-based, imidazole-based, and piperidine-based ionic liquids. Suitable ionic liquids may include, but are not limited to, N-methyl-N-ethylpyrrolidinium bis(trifluoromethylsulfonyl)imide, N-butyl-N-methylpyrrolidinium bis(trifluoromethanesulfonyl)imide, 1-allyl-3-methylimidazolium bis(trifluoromethylsulfonyl)imide, 1-ethyl-3-methylimidazolium chloride, 1-ethyl-3-methylimidazolium bis(trifluoromethylsulfonyl)imide, 1-butyl-3-methylimidazolium bis(trifluoromethylsulfonyl)imide, 1-hexyl-3-methylimidazolium bis(trifluoromethylsulfonyl)imide, 1-vinyl-3-butylimidazolium bis(trifluoromethylsulfonyl)imide, N-hexyl-4-methylpyridinium bis(trifluoromethylsulfonyl)imide, N-ethylpyridinium bis(trifluoromethanesulfonyl)imide, N-butylpyridinium trifluoromethanesulfonate, N-hexyl-N-methylpiperidinium bis(trifluoromethanesulfonyl)imide, or any combinations thereof, etc. In some embodiments, the total amount of the ionic liquid(s) may range from 2 wt % to about 20 wt %, based on the total weight of the solid polymer electrolyte.

According to the present application, the one or more polymers may include one or more of C, N, O, H, F, etc. Suitable polymers may include, but are not limited to, polymethyl methacrylate (PMMA), polytetrafluoroethylene (PTFE), polyvinylidene fluoride (PVDF), poly(vinylidene fluoride-co-hexafluoropropylene) (PVDF-HFP), polyethylene oxide, polyethylene glycol diglycidyl ether, polyethylene glycol diacrylate, polyethylene terephthalate, or any combinations thereof, etc. In an embodiment where multiple polymers are present, the polymers may be crosslinked to form a mechanically enhanced network. In some embodiments, the total amount of the polymer(s) may range from 0 wt % to about 20 wt %, based on the total weight of the solid polymer electrolyte.

According to the present application, the one or more electrolyte salts may include one or more metal salts. Suitable electrolyte salts may include organic lithium salts and inorganic lithium salts, including but not limited to LiBOB (lithium bis(oxalato)borate), LiFSI (lithium bis(fluorosulfonyl)imide), LiTFSI (lithium bis(trifluoromethanesulfonyl)imide), LiPF₆, LiBF₄, LiClO₄, LiCF₃SO₃, or any combinations thereof, etc. In some embodiments, the total amount of the electrolyte salt(s) may range from about 10 wt % to about 40 wt %, based on the total weight of the solid polymer electrolyte.

According to the present application, the one or more curing agents may include, but is not limited to, polyamide, triethylene tetramine, tetraethylene pentamine, m-xylylenediamine, trimethylolpropane tris(3-mercaptopropionate), phthalic anhydride, methylcyclohexenetetracarboxylic dianhydride, or any combinations thereof, etc. In some embodiments, the total amount of the curing agent(s) may range from about 2 wt % to about 15 wt %, based on the total weight of the solid polymer electrolyte.

According to the present application, the one or more solvents may include, but is not limited to, isopropanol, sec-butanol, butanone, propylene glycol methyl ether acetate, propylene carbonate, diethyl carbonate, or any combinations thereof, etc. In some embodiments, the total amount of the solvent(s) may range from about 0 wt % to about 70 wt %, based on the total weight of the solid polymer electrolyte.

The solid polymer electrolyte of the present application is prepared by coating a substrate via slot die coating, drying the solvent and then completing thermal curing or UV curing in an oven to give a solid polymer electrolyte.

The electrochromic device of the present application includes a first electrode, a second electrode, a charge storage layer and an electrochromic material respectively deposited on the electrodes, and a solid polymer electrolyte disposed therein. Materials for the first and second electrodes may include, but are not limited to, tin-doped indium oxide (ITO), fluorine-doped indium oxide, zinc-doped indium oxide, silver nanowires, carbon nanotube films, patterned metals on glass or plastic substrates, or any combinations thereof, and/or other such transparent materials exhibiting sufficient electrical conductance. The charge storage layer material deposited on the first electrode may include a metal oxide, such as MoO₃, V₂O₅, Nb₂O₅, WO₃, TiO₂, Ir(OH)ₓ, SrTiO₃, ZrO₂, La₂O₃, CaTiO₃, sodium titanate, potassium niobate, combinations thereof, etc. The electrochromic material on the second electrode may include a conductive polymer, such as poly-3,4-ethylenedioxythiophene (PEDOT), poly-2,2′-bithiophene, polypyrrole, polyaniline (PANI), polythiophene, polyisothianaphthene, poly(o-aminophenol), polypyridine, polyindole, polycarbazole, polyquinone, octacyanophthalocyanine, or any combinations thereof, etc.

### EXAMPLES

8 g of PVDF polymer was combined with a certain amount (e.g., 5 g, 10 g, or 15 g) of PEO oligomer. The combined components were dissolved in 20 g or 30 g of butanone, and 5 g, 10 g, or 15 g of ionic liquid N-methyl-N-ethylpyrrolidinium bis(trifluoromethylsulfonyl)imide to obtain a solution. 10 g, 12 g, or 15 g of LiTFSI was dissolved in 8 g, 10 g, or 12 g of butanone and then added to the above mixed solution. 5 g or 10 g of polyamide was dissolved in the solution and stirred well. The resulting solution was deposited on a charge storage layer via slot die coating or spin coating, for example. After drying the solvent, the solution was heated in an oven at 110° C. for 10 min. Then, the resulting completely cured material and an electrochromic layer were laminated to obtain an electrochromic film, which may be used to assemble an electrochromic device.

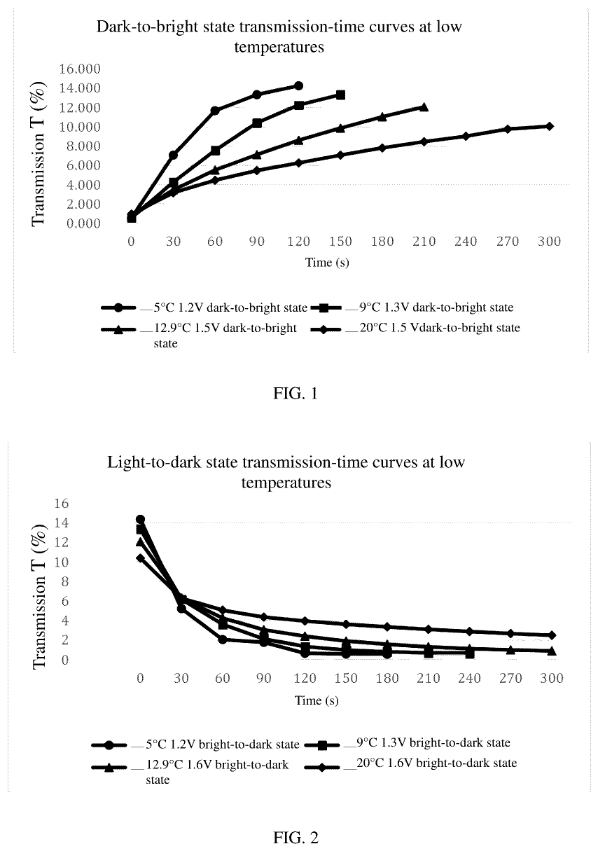

FIG. 1 provides dark-to-bright state transmission-time curves of a 500 mm*500 mm electrochromic device including a low-temperature solid polymer electrolyte therein, according to an exemplary embodiment, measured at −5° C., −9° C., −12.9° C., and −20° C.

FIG. 2 provides bright-to-dark state transmittance-time curves of a 500 mm*500 mm electrochromic device assembled according to an exemplary embodiment, measured at −5° C., −9° C., −12.9° C., and −20° C.

It can be seen from the results of FIGS. 1 and 2 that the low-temperature solid polymer electrolyte of the present application, when used in an electrochromic device, enables the electrochromic device to still operate normally at low temperatures.

### Applications/Uses

Embodiments of the presently disclosed low-temperature solid polymer electrolyte may be used in various applications, devices, industries etc. Particular applications of the presently disclosed solid polymer electrolyte involve use in electrochromic devices. Electrochromic devices are often associated with smart window and display technology, e.g., anti-glare car mirrors; smart windows configured to modulate the transmission or reflect solar radiation for use in cars, aircrafts, buildings, and the like; protective eyewear; camouflage and/or chameleonic materials; etc.

The above are only preferred embodiments of the application and do not limit the invention in any form or essence. It should be pointed out that a person skilled in the art can make several improvements and supplements without departing from the invention, and these improvements and supplements should also be regarded as falling within the scope of the invention.

What is claimed is:

1. A low-temperature solid polymer electrolyte, comprising:
one or more ionic liquids;
one or more polymers;
one or more electrolyte salts;
one or more curing agents; and
one or more solvents.

2. The low-temperature solid polymer electrolyte according to claim 1, wherein the one or more ionic liquids comprise one or more of pyridine-based, pyrrole-based, imidazole-based, and piperidine-based ionic liquids;
and/or, the one or more electrolyte salts comprise one or more metal salts;
and/or, the one or more curing agent comprise one or more of an amine-based curing agent, an anhydride-based curing agent, and a thiol-based curing agent.

3. The low-temperature solid polymer electrolyte according to claim 1, wherein the one or more polymers comprise one or more of polymethyl methacrylate (PMMA), polytetrafluoroethylene (PTFE), polyvinylidene fluoride (PVDF), poly(vinylidene fluoride-co-hexafluoropropylene) (PVDF-HFP), polyethylene oxide, polyethylene glycol diglycidyl ether, polyethylene glycol diacrylate, and polyethylene terephthalate.

4. The low-temperature solid polymer electrolyte according to claim 1, wherein the one or more ionic liquids comprise one or more of N-methyl-N-ethylpyrrolidinium bis(trifluoromethylsulfonyl)imide, N-butyl-N-methylpyrrolidinium bis(trifluoromethanesulfonyl)imide, 1-allyl-3-methylimidazolium bis(trifluoromethylsulfonyl)imide, 1-ethyl-3-methylimidazolium chloride, 1-ethyl-3-methylimidazolium bis(trifluoromethylsulfonyl)imide, 1-butyl-3-methylimidazolium bis(trifluoromethylsulfonyl)imide, 1-hexyl-3-methylimidazolium bis(trifluoromethylsulfonyl)imide, 1-vinyl-3-butylimidazolium bis(trifluoromethylsulfonyl)imide, N-hexyl-4-methylpyridinium bis(trifluoromethylsulfonyl)imide, N-ethylpyridinium bis(trifluoromethanesulfonyl)imide, N-butylpyridinium trifluoromethanesulfonate, and N-hexyl-N-methylpiperidinium bis(trifluoromethanesulfonyl)imide.

5. The low-temperature solid polymer electrolyte according to claim 2, wherein the metal salt is a metal lithium salt.

6. The low-temperature solid polymer electrolyte according to claim 5, wherein the metal lithium salt comprises one or more of LiBOB, LiFSI, LiTFSI, LiPF₆, LiBF₄, LiClO₄ and LiCF₃SO₃.

7. The low-temperature solid polymer electrolyte according to claim 2, wherein the amine-based curing agent comprises one or more of polyamide, triethylene tetramine, tetraethylene pentamine, and m-xylylenediamine;
and/or, the anhydride-based curing agent comprises one or more of phthalic anhydride, methylcyclohexenetetracarboxylic dianhydride, and methylcyclohexenetetracarboxylic dianhydride;
and/or, the thiol-based curing agent comprises one or more of ethylene glycol dimercaptoacetate, 1,4-butanediol bis(3-mercaptopropionate), and trimethylolpropane tris (3-mercaptopropionate).

8. The low-temperature solid polymer electrolyte according to claim 1, wherein the one or more solvents comprises a solvent with a boiling point above 60° C.

9. The low-temperature solid polymer electrolyte according to claim 8, wherein the one or more solvents comprise one or more of isopropanol, sec-butanol, butanone, propylene glycol methyl ether acetate, propylene carbonate, and diethyl carbonate.

10. The low-temperature solid polymer electrolyte according to claim 1, wherein the low-temperature solid polymer electrolyte has a transparency of at least 80%.

11. An electrochromic device comprising a low-temperature solid polymer electrolyte, wherein the low-temperature solid polymer electrolyte, comprises:
one or more ionic liquids;
one or more polymers;
one or more electrolyte salts;
one or more curing agents; and
one or more solvents.

12. The electrochromic device according to claim 11, wherein the one or more ionic liquids comprise one or more of pyridine-based, pyrrole-based, imidazole-based, and piperidine-based ionic liquids;
and/or, the one or more electrolyte salts comprise one or more metal salts;
and/or, the one or more curing agent comprise one or more of an amine-based curing agent, an anhydride-based curing agent, and a thiol-based curing agent.

13. The electrochromic device according to claim 11, wherein the one or more polymers comprise one or more of polymethyl methacrylate (PMMA), polytetrafluoroethylene (PTFE), polyvinylidene fluoride (PVDF), poly(vinylidene fluoride-co-hexafluoropropylene) (PVDF-HFP), polyethylene oxide, polyethylene glycol diglycidyl ether, polyethylene glycol diacrylate, and polyethylene terephthalate.

14. The electrochromic device according to claim 11, wherein the one or more ionic liquids comprise one or more of N-methyl-N-ethylpyrrolidinium bis(trifluoromethylsulfonyl)imide, N-butyl-N-methylpyrrolidinium bis(trifluoromethanesulfonyl)imide, 1-allyl-3-methylimidazolium bis(trifluoromethylsulfonyl)imide, 1-ethyl-3-methylimidazolium chloride, 1-ethyl-3-methylimidazolium bis(trifluoromethylsulfonyl)imide, 1-butyl-3-methylimidazolium bis(trifluoromethylsulfonyl)imide, 1-hexyl-3-methylimidazolium bis(trifluoromethylsulfonyl)imide, 1-vinyl-3-butylimidazolium bis(trifluoromethylsulfonyl)imide, N-hexyl-4-methylpyridinium bis(trifluoromethylsulfonyl)imide, N-ethylpyridinium bis(trifluoromethanesulfonyl)imide, N-butylpyridinium trifluoromethanesulfonate, and N-hexyl-N-methylpiperidinium bis(trifluoromethanesulfonyl)imide.

15. The electrochromic device according to claim 12, wherein the metal salt is a metal lithium salt.

16. The electrochromic device according to claim 15, wherein the metal lithium salt comprises one or more of LiBOB, LiFSI, LiTFSI, LiPF₆, LiBF₄, LiClO₄ and LiCF₃SO₃.

17. The electrochromic device according to claim 12, wherein the amine-based curing agent comprises one or more of polyamide, triethylene tetramine, tetraethylene pentamine, and m-xylylenediamine;
and/or, the anhydride-based curing agent comprises one or more of phthalic anhydride, methylcyclohexenetetracarboxylic dianhydride, and methylcyclohexenetetracarboxylic dianhydride;
and/or, the thiol-based curing agent comprises one or more of ethylene glycol dimercaptoacetate, 1,4-butanediol bis(3-mercaptopropionate), and trimethylolpropane tris (3-mercaptopropionate).

18. An electrochromic device, comprising:
a first electrode;
a second electrode;
an electrochromic material deposited on at least the first electrode; and
a low-temperature solid polymer electrolyte arranged between the electrochromic material and the second electrode, wherein the low-temperature solid polymer electrolyte, comprises:
one or more ionic liquids;
one or more polymers;
one or more electrolyte salts;
one or more curing agents; and
one or more solvents.

19. The electrochromic device according to claim 18, wherein the one or more ionic liquids comprise one or more of pyridine-based, pyrrole-based, imidazole-based, and piperidine-based ionic liquids;
and/or, the one or more electrolyte salts comprise one or more metal salts;
and/or, the one or more curing agent comprise one or more of an amine-based curing agent, an anhydride-based curing agent, and a thiol-based curing agent.

20. The electrochromic device according to claim 18, wherein the one or more polymers comprise one or more of polymethyl methacrylate (PMMA), polytetrafluoroethylene (PTFE), polyvinylidene fluoride (PVDF), poly(vinylidene fluoride-co-hexafluoropropylene) (PVDF-HFP), polyethylene oxide, polyethylene glycol diglycidyl ether, polyethylene glycol diacrylate, and polyethylene terephthalate.
